(19) United States
(12) Patent Application Publication
(10) Pub. No.: US 2009/0058637 A1
(43) Pub. Date: Mar. 5, 2009

(54) MULTI-ANTENNA WIRELESS SENSOR SYSTEM

(75) Inventors: Terry B.J. Kuo, Hualien County (TW); Cheryl C. H. Yang, Hualien County (TW); Guo-She Lee, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL YANG-MING UNIVERSITY, Taipei City (TW)

(21) Appl. No.: 12/139,847

(22) Filed: Jun. 16, 2008

(30) Foreign Application Priority Data
Aug. 27, 2007 (TW) 096131616

(51) Int. Cl. H04Q 7/00

(52) U.S. Cl. 340/539.12

(57) ABSTRACT

The present invention relates to a multi-antenna wireless sensor system that allows a subject to measure and transmit physiological signals, comprising a wireless sensor, a wireless base station, a network device, and a data processing unit. The wireless sensor senses and collects the physiological signals of the subject and contains a portable electronic device with a wireless data transmission interface.

### FIELD OF THE INVENTION

The present invention relates to a multi-antenna wireless sensor system, more particularly a sensor system that remotely monitors wireless physiological signal sensor and feedback data through a wireless base station arranged with a plurality of wireless transceivers and a network device.

### DESCRIPTION OF PRIOR ART

Many conventional physiological signal monitoring devices, such as the sleep monitoring system, are built on wired transmission technology that means wires have to be attached to subjects' body, and they are connected to a huge and heavy machine which would restrict the movement of the subjects and at times makes it hard for them to go to bathrooms. That is one of the reasons that keep many patients with sleep disorder from having examination in hospitals. It also takes a lot of time to train technicians to conduct the examination in the hospitals.

Wireless devices can be categorized into different classes by the radiation emitted. For example, a radio station emits kW radiation, and a mobile phone emits 1 W radiation. However, studies on the long-term exposure to such radiation have not been well established and the effects of such radiation on people are inconclusive. Naturally people are apprehensive about the possible harmful effect of radio waves on brain. Recently some computer peripherals switch to wireless network or Bluetooth system with less energy consumption for signal transmission. Some low energy systems have even been applied to wireless mouse or keyboard. Generally speaking, people are weary of the possible health hazard of radiation while enjoying the convenience brought about by wireless products. Even though theoretically radiation emitted by wireless systems is proven harmless, wave interference between machines are not acceptable. Since the use of low energy in radio transmission has become a trend, low-energy systems are more readily accepted for use at home and in hospitals. Low energy also means lighter weight and more compact in size, and usually costs less. However, the application of low energy system produces some limitations on the detection of physiological signals because small emission power limits the range of transmission to 10 meters; therefore, once the user moves, the signals disappear. Since low radiation energy is favored by consumers, the only way to enhance the quality of wireless transmission is to increase the quantity or distribution density of receivers.

### BRIEF DESCRIPTION OF THE DRAWINGS

FIG. 1 shows the schematic diagram of the multi-antenna wireless sensor system of the invention.

(1) wireless sensor;

(2) wireless base station;

(21) first wireless transceiver;

(22) second wireless transceiver;

(23) third wireless transceiver;

(3) network device;

(31) network server;

(4) data processing unit

(41) monitor.

FIG. 2 shows the schematic diagram of the multi-antenna wireless sensor system according to an embodiment of the invention.

FIG. 3 shows the schematic diagram of the multi-antenna wireless sensor system according to another embodiment of the invention.

FIG. 4 shows an electrocardiogram of the subject detected by the physiological signal collecting device of the wireless sensor.

FIG. 5 shows an electrocardiogram output by the wireless sensor and received by the wireless base station.

FIG. 6 shows the signals detected from a subject during a 5-second walk.

FIG. 7 shows the signals detected from a subject during a 60-second walk.

FIG. 8 shows the signals detected from a subject during a 40-minute walk.

FIG. 9 shows the frequency spectrogram of original signals, the frequency spectrogram of wireless signals, correlation analysis chart, phase difference diagram, and amplitude ratio diagram.

FIG. 10 shows the heartbeat interval signals detected from a subject during a 40-minute walk.

FIG. 11 shows the heart rate variability (HRV) detected from a subject during a 40-minute walk.

FIG. 12 shows the frequency spectrogram of original heartbeat interval signals, the frequency spectrogram of wireless heartbeat interval signals, correlation analysis chart, phase difference diagram, and amplitude ratio diagram.

### SUMMARY OF THE INVENTION

The present invention relates to a multi-antenna wireless sensor system that allows a user to measure and transmit physiological signals, comprising a wireless sensor, a wireless base station, a network device, and a data processing unit. The wireless sensor can sense and collect the physiological signals of user and contains a portable electronic device with a wireless data transmission interface. The wireless base station contains a wireless communication apparatus having a plurality of wireless transceivers. Through the arrangement of those wireless transceivers, the wireless sensor can remotely or movably maintain data communication with the data processing unit, and the output signals of wireless sensor are transmitted to the data processing unit through the wireless base station and the network device for the post-processing of feedback data.

### DETAILED DESCRIPTION OF THE INVENTION

The basic concept of the present invention is to achieve perfect low-power wireless transmission of physiological signals by increasing the quantity and distribution of receivers. In view of the drawback of conventional physiological signal monitoring devices, the present invention aims to provide a multi-antenna wireless sensor system that answers to contemporary needs.

An object of the present invention is to provide a multi-antenna wireless sensor system that uses a wireless physiological signal monitoring device capable of collecting electric physiological signals and transmitting wirelessly, and a reliable and low-cost network device for data transmission between the multi-antenna wireless sensor system and data processing unit to achieve the functions of remote and real-time monitoring and feedback of physiological signals.

Another object of the present invention is to provide a multi-antenna wireless sensor system which, through the arrangement of a plurality of wireless transceivers, lowers the power of radio transmitters, thereby reducing their interference or effect on instrumentation or humans while achieving remote monitor.

Yet another object of the present invention is to provide a multi-antenna wireless sensor system which, through integration of synchronous receiving technology and physiological signal sensing technologies in the aforementioned wireless physiological signal monitoring device and the wireless base station with a plurality of wireless transceivers, can realize a totally wireless, easy-to-use, and accurate physiological signal monitoring system that is not confined by space or distance and is applicable to exercise testing, home care, and in-hospital observation. Such system can also be applied in the study of neuroscience, behavioral science, biofeedback (e.g. electroencephalogram (EEG) feedback to cut down dozing off during work), maintenance of cardiac and circulation system and routine activities to realize ultimately an intelligent PC-doctor system.

To achieve the aforesaid objects, the multi-antenna wireless sensor system allows the user to measure physiological signals and transmit the same, comprising a wireless sensor, a wireless base station, a network device, and a data processing unit. The wireless sensor can detect and collect the physiological signals of user and contain a portable electronic device having wireless data transmission interface. The wireless base station contains a wireless communication apparatus having a plurality of wireless transceivers. Through the arrangement of those wireless transceivers, the wireless sensor can remotely or movably maintain data communication with the data processing unit, and the output signals of wireless sensor are transmitted to the data processing unit through the wireless base station and the network device for the post-processing of feedback data.

The multi-antenna wireless sensor system transmits digital physiological signals intermittently to the wireless transceivers. The content of each transmission also includes the time of the data. The transmitted data can be fed to the data processing unit via any transceiver. If multiple wireless transceivers receive the data sent by the multi-antenna wireless sensor system at the same time, data received can be screened and integrated based on the temporal information of data without undermining the data accuracy.

The data processing unit calculates the position of wireless sensor based on the transmission sequential difference between the wireless transceivers of the wireless base station and the coordinates of each wireless transceiver.

The wireless sensor further includes a physiological signal collecting device that outputs a physiological signal corresponding to the physiological state of the user; a control module consisting of an electrical loop with a signal processing means; a wireless transmission module which is a wireless data transmission interface; and a power supply unit, which is a portable power source and supplies power needed by the wireless sensor. The power supply unit includes a rechargeable secondary battery is lithium, nickel-metal-hydride or lead-acid batteries. The power supply unit can also be a portable power generating apparatus selected from fuel cell and solar cell. The physiological signal collecting device can detect neural signals, electrocardiogram (ECG) signals, electromyogram (EMG) signals, and vocal signals.

The physiological signal collecting device can also be an electrocardiogram signal collecting device to detect electrocardiogram signals. The physiological signal collecting device comprises an amplifier module. The amplifier module further consists of an input filter, a differential amplifier, and an output filter. The input filter filters out noise to enhance the signal-to-noise ratio. The differential amplifier subjects the signal input by electrodes to common-mode noise attenuation and amplifies the electrocardiogram signal differential by a proper factor. The output filter eliminates the Nyquist frequency of differential amplified signal.

The wireless transmission module further comprises an antenna device and a modulator-demodulator. The antenna device can emit signals output by wireless sensor to the wireless base station and receive wireless signals emitted by the wireless base station. The modulator-demodulator modulates the electrical signal output by the control module into carrier wave of specific frequency and sends it to the wireless base station via the antenna device. The modulator-demodulator also demodulates the signals received by the antenna device into a digital signal and transmits it to the control module of wireless sensor for corresponding computing or operation.

In addition, the wireless transmission module can receive and convert the data sent by the wireless base station into electrical signal and transmit the signal to the wireless sensor.

The control module consists of an analog-digital converter and a microprocessor. The analog-digital converter converts the analog signal output by the amplifier module into a digital signal with proper voltage resolution and sampling frequency. The microprocessor compresses the digital signal output by the analog-digital converter to generate a digital electrocardiogram signal.

The network device further comprises a network server that carries out network addressing and data package exchange with the wireless sensor through electrical connection of network device and wireless transmission of wireless base station, and further allows the data processing unit to remotely monitor or control the wireless sensor.

The data processing unit further comprises a monitor, which has display and operation functions to enable the user to monitor or control the various operations of wireless sensor.

The wireless sensor further comprises a positioning device, which is an electric device compatible with the global positioning system and contains a positioning-satellite-signal-receiving means and a means that converts satellite signal into position signal to respectively receive the signal transmitted by a positioning satellite and convert the satellite signal received into a position signal, and then transmit the position signal to the microprocessor of control module. The microprocessor controls the transmission of said position signal to wireless base station through the wireless transmission module. Finally the signal is transmitted to the data processing unit through the network device to let the data processing unit obtain the location of the wireless sensor.

The positioning satellite-signal-receiving means is a satellite signal receiver. The means that converts satellite signal to position signal is an electrical loop where the satellite signal received by the positioning device is converted into a position signal by the control module and sent to the data processing unit via the wireless transmission module and the network device. The positioning satellite signal receiving means is achieved by a satellite signal receiver, while the means to convert satellite signal into position signal is achieved by the microprocessor of control module, or its electrical loop configuration is integrated in the control module.

The objects, features and function of the invention as well as implementation of the invention are described in detail below with embodiments in reference to the accompanying drawings.

### EXAMPLES

The examples below are non-limiting and are merely representative of various aspects and features of the present invention.

### Example 1

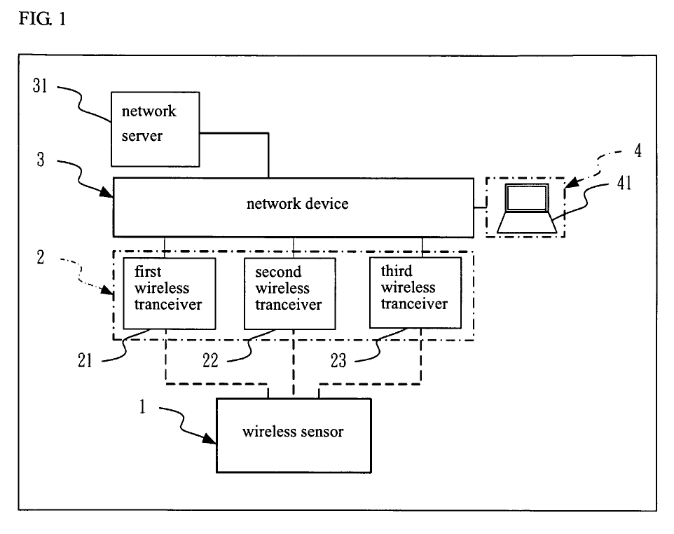

Referring to FIG. 1 which shows a schematic diagram of the multi-antenna wireless sensor system of the invention, the multi-antenna wireless sensor system of the invention primarily uses a wireless sensor (1) to detect the physiological condition or location of a subject and provide a feedback, which is then transmitted wirelessly to a data processing unit (4) through a wireless base station (2) and a network device (3), where the feedback information is subject to post processing so as to collect information on or monitor the physiological state or location of the subject.

The wireless base station (2) is electrically connected to a wireless communication facility of the network device (3) to allow data exchange between them. That is, the wireless base station (2) is a physical extension of the electrical connection of network device (3). The wireless base station (2) comprises a plurality of wireless transceivers; through the arrangement of the wireless transceivers, the wireless sensor (1) remotely or movably maintains data communication with the data processing unit (4). Specifically, the wireless base station (2) consists of a first wireless transceiver (21), a second wireless transceiver (22), and a third wireless transceiver (23). Based on the sequential differences of transmission between the wireless sensor (1) and the first wireless transceiver (21), the second wireless transceiver (22), and the third wireless transceiver (23) respectively, and coordinates of each transceiver, the data processing unit (4) can calculate the location of the wireless sensor (1) corresponding to the transceivers. In the case of application to hospital patients, when a patient under monitoring is walking around in the hospital, wireless transceivers in the wireless base station (2) would receive signal from the wireless sensor (1) and send the signal to data processing unit (4) for determination of the location of wireless sensor (1) that allows hospital personnel to know the location of the patient. If the patient is in emergency, the hospital personnel will be able to arrive at where the patient is located in the shortest time or deal with the patient easily.

### Example 2

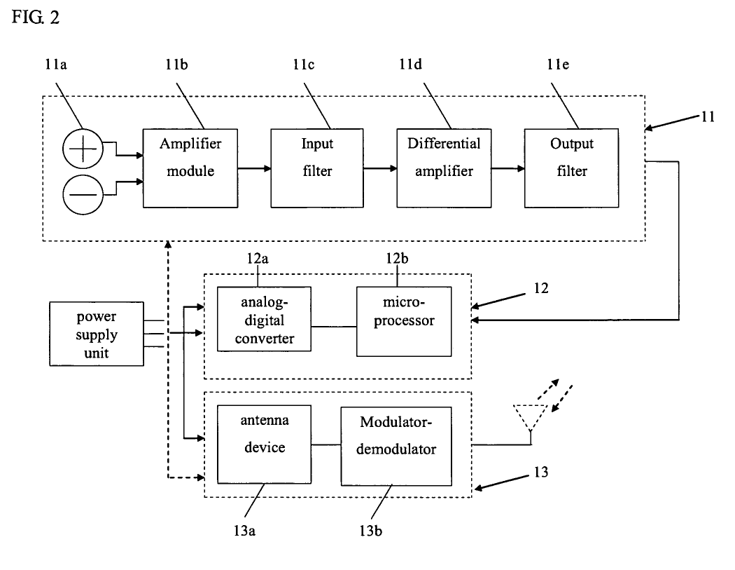

Referring to FIG. 2 which shows a schematic diagram of the multi-antenna wireless sensor system according to an embodiment of the invention, the wireless sensor (1) of the multi-antenna wireless sensor system is a portable electrical device comprising a physiological signal collecting device (11), a control module (12), a wireless transmission module (13), and a power supply unit (14). The physiological signal collecting device (11) is a micro physiological signal sensor capable of detecting one or more types of signals including neural signals, electrocardiogram signals, electromyogram signals, gravity acceleration, temperature, and vocal signals to collect information on the physiological state or needs of a user and outputting a physiological signal corresponding to the physiological state of the user. The control module (12) processes the information collected by the physiological signal collecting device (11) and converts it into corresponding electrical data, i.e. it processes the physiological signal and converts it into an electrical signal. The wireless transmission module (13) is a wireless data transmission interface having the same wireless transmission protocol as that of wireless base station (2) to enable data exchange with the wireless base station (2). The wireless transmission module (13) converts the information output by wireless sensor (1) into a wireless signal and transmits it to the wireless base station (2), or it receives the data sent by wireless base station (2), converts the data into an electrical signal, and transmits it to the wireless sensor (1). The power supply unit (14) is a portable power that can be a rechargeable secondary battery, such as lithium, nickel-metal-hydride, or lead-acid battery, or a portable power generating apparatus, such as fuel cell or solar cell that supplies power needed by the wireless sensor (1).

The physiological signal collecting device (11) can be an electrocardiogram signal collecting device, comprising a set of electrodes (11a) and an amplifier module (11b). The amplifier module (11b) further consists of an input filter (11c), a differential amplifier (11d), and an output filter (11e). The electrodes (11a) are adhered to the user, through which, user's electrocardiogram signals are collected. The input filter (11c) filters out noise to enhance the signal-to-noise ratio of electrocardiogram signal collected. The differential amplifier (11d) subjects the signal input by the electrodes (11a) to common-mode noise attenuation and amplify the signal differential by a proper factor. Finally, the output filter (11e) eliminates the Nyquist frequency of differential amplified signal to facilitate data conversion by control module (12).

The control module (12) consists of an analog-digital converter (12a) and a microprocessor (12b). The analog-digital converter (12a) converts the analog signal output by amplifier module (11b) into a digital signal with proper voltage resolution and sampling frequency. The microprocessor (12b) compresses the digital signal output by the analog-digital converter (12a) to generate a digital electrocardiogram signal.

The wireless transmission module (13) further includes an antenna device (13a) and a modulator-demodulator (13b). The antenna device (13a) emits signals output by wireless sensor (1) to the wireless base station (2) and receives wireless signals emitted by the wireless base station (2). The modulator-demodulator (13b) modulates the digital electrocardiogram signal output by the control module (12) to carrier wave of specific frequency and sends it to the wireless base station (2) via the antenna device (13a). The modulator-demodulator (13b) also demodulates the signal received by the antenna device (13a) into a digital signal and transmits it to the control module (12) of wireless sensor (1) for corresponding computing or operation.

The network device (3) further comprises a network server (31) that carries out network addressing and packet exchange with the wireless sensor (1) through electrical connection of network device (3) and wireless transmission of wireless base station (2), and further allows the data processing unit (4) to remotely monitor or control the wireless sensor (1). Furthermore, the network device (3) is a regular network that can engage in one-way or two-way transmission or communication with an electrical device. For example, the network device (3) is the intranet of a hospital or Internet, or a network built for the specific purpose of the multi-antenna wireless sensor system of the invention.

The data processing unit (4) further comprises a monitor (41), which has display and operation functions to enable the user to monitor or control the various operations of wireless sensor (1).

### Example 3

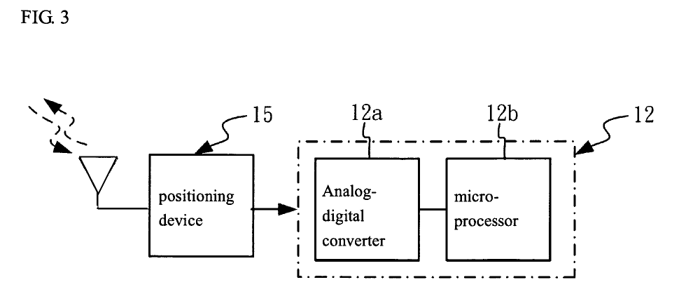

Referring to FIG. 3 which shows a schematic diagram of the multi-antenna wireless sensor system according to another embodiment of the invention, the wireless sensor (1) of the multi-antenna wireless sensor system further comprises a positioning device (15), which is an electric device compatible with the global positioning system (GPS) and contains a positioning-satellite-signal-receiving means and a means to convert satellite signal into position signal to respectively receive the signal transmitted by a positioning satellite and convert the satellite signal received into a position signal, and then transmit the position signal to the microprocessor (12b) of control module (12). The microprocessor (12b) controls the transmission of said position signal to wireless base station (2) through the wireless transmission module (13). Finally the signal is transmitted to the data processing unit (4) through the network device (3) in FIG. 1 to let the data processing unit (4) obtain the location of the wireless sensor (1). The positioning-satellite-signal-receiving means is a satellite signal receiver. The means that converts satellite signal to position signal is achieved via an electrical loop or the microprocessor (12b) of control module (12). The electrical loop configuration can be integrated in the control module (12). When the positioning device (15) receives a satellite signal, the control module (12) transmits the position signal to the data processing unit (4) through wireless transmission module (13) and network device (3).

### Example 4

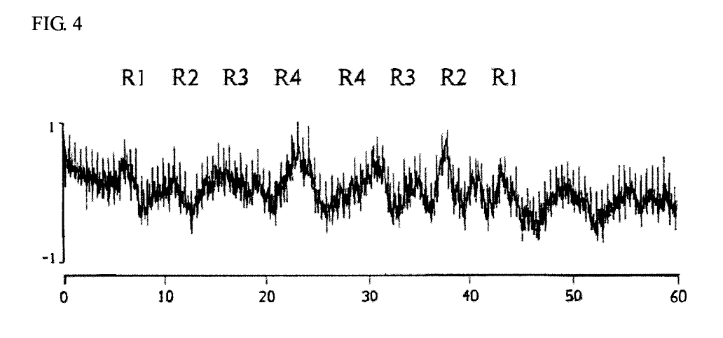

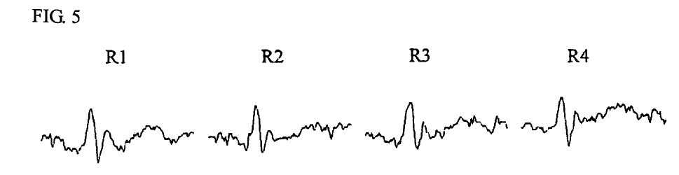

FIG. 4 shows an electrocardiogram of the subject detected by the physiological signal-collecting device of the wireless sensor. FIG. 5 shows an electrocardiogram output by the wireless sensor and received by the wireless base station. In FIG. 4, a subject carries the wireless sensor (1) and passes through four wireless transceivers of wireless base station (2). While the subject moves, the physiological signal collecting device (11) of wireless sensor (1) collects simultaneously the electrocardiogram signals of the subject in segments in the sequence of R1, R2, R3, R4, R4, R3, R2, and R1. In FIG. 5, wireless base station (2) receives the signals emitted by wireless sensor (1) and transmits the signals to data processing unit (4), which then outputs corresponding signals R1, R2, R3 and R4. As shown, the signals from wireless sensor (1) received by wireless base station (2) match the electrocardiogram signals collected by the physiological signal collecting device (11), demonstrating the practical application of the wireless sensor in the multi-antenna wireless sensor system of the invention.

### Example 5

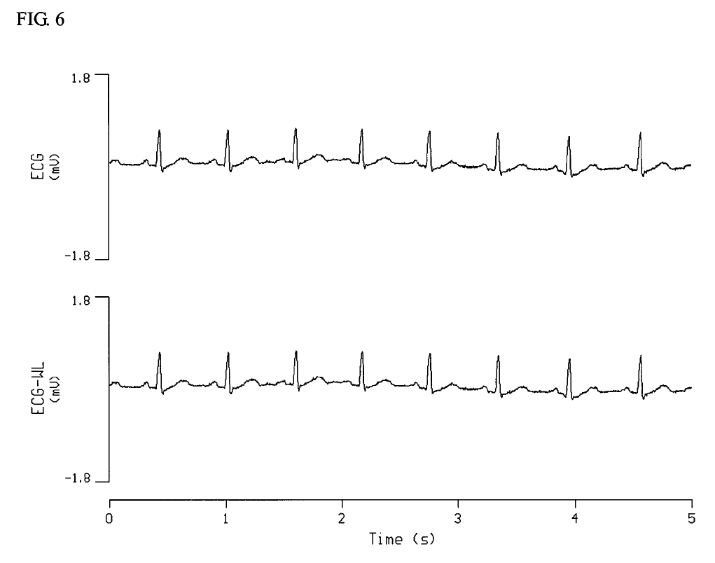

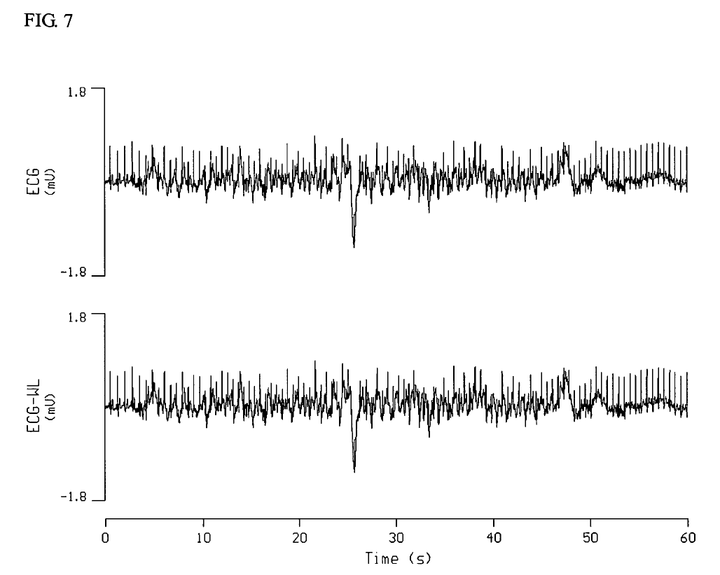

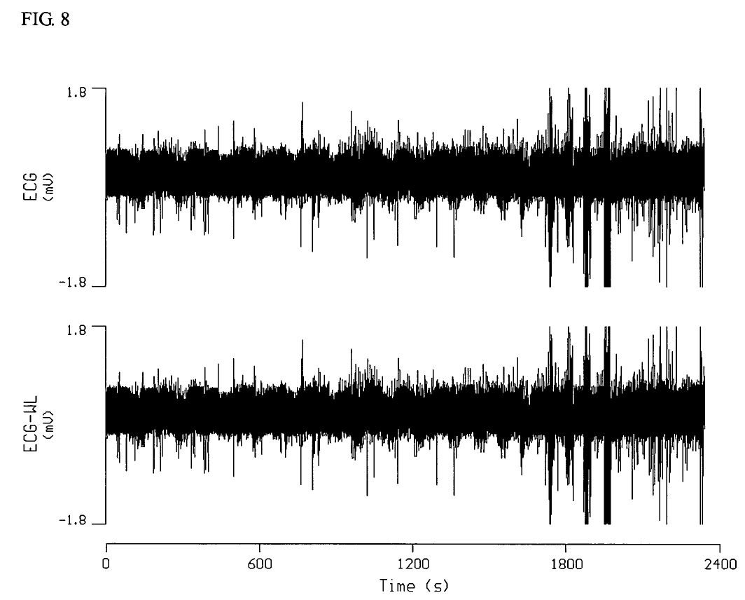

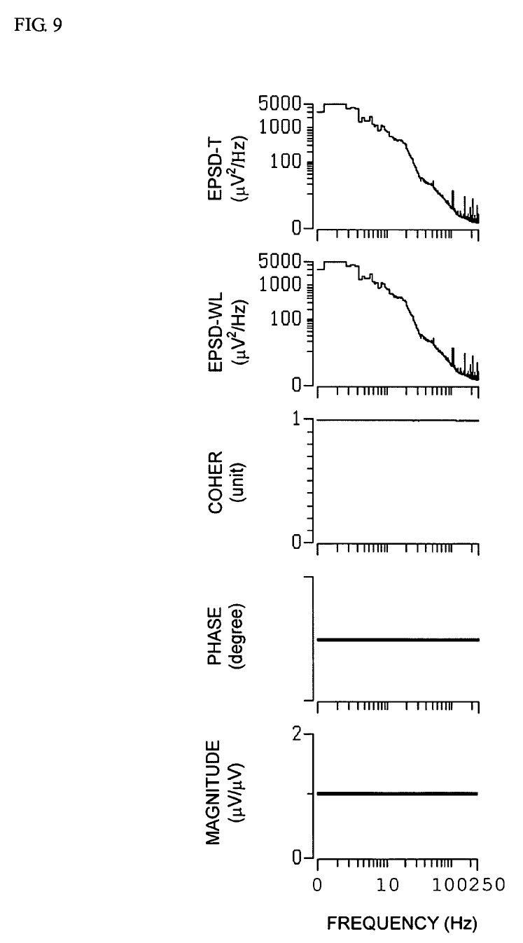

Referring to FIG. 6, the top part of FIG. 6 shows the signals from a subject as detected by the physiological signal-collecting device (11) of wireless sensor (1) during a 5-second walk; the bottom part shows the signals emitted by the physiological signal collecting device (11) of wireless sensor (1) as received by the wireless base station (2) during the subject's walk. Referring to FIG. 7, the top part of FIG. 7 shows the signals from a subject as detected by the physiological signal-collecting device (11) of wireless sensor (1) in the process of a 60-second walk; the bottom part shows the signals emitted by the physiological signal-collecting device (11) of wireless sensor (1) as received by the wireless base station (2) during 60-second walk. Referring to FIG. 8, the top part of FIG. 8 shows the signals from a subject as detected by the physiological signal collecting device (11) of wireless sensor (1) during 40-minute walk; the bottom part shows the signals emitted by the physiological signal-collecting device (11) of wireless sensor (1) as received by the wireless base station (2) during 40-minute walk. FIG. 9 shows, from top to bottom, the frequency spectrogram of original signals, the frequency spectrogram of wireless signals, correlation analysis chart, phase difference diagram, and amplitude ratio diagram, in which the frequency spectrogram of the original signals approximates that of the wireless signals. The correlation analysis shows correlation of 1 between the original signals and wireless signals in the range of 0 to 250 Hz. The phase difference between the original signals and wireless signals approaches 0. The amplitude ratio of original signals and wireless signals also approaches 1. It can be observed from the experimental results that signals detected by the physiological signal collecting device (11) match the signals received by wireless base station (2).

### Example 6

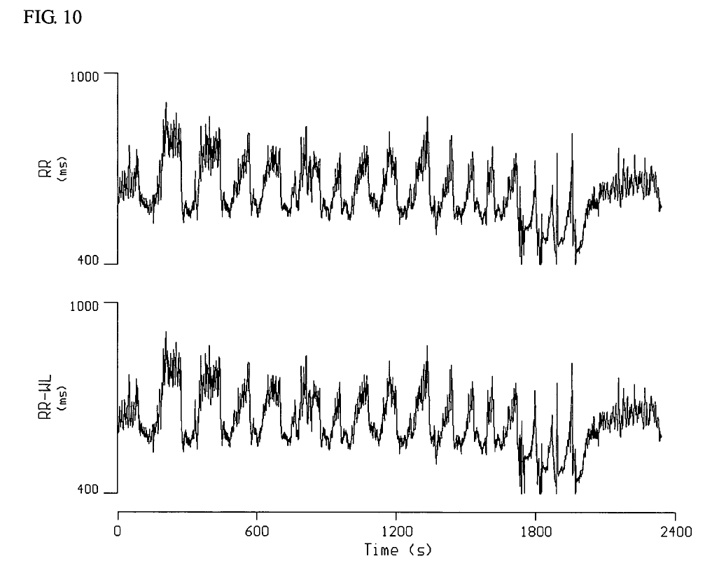

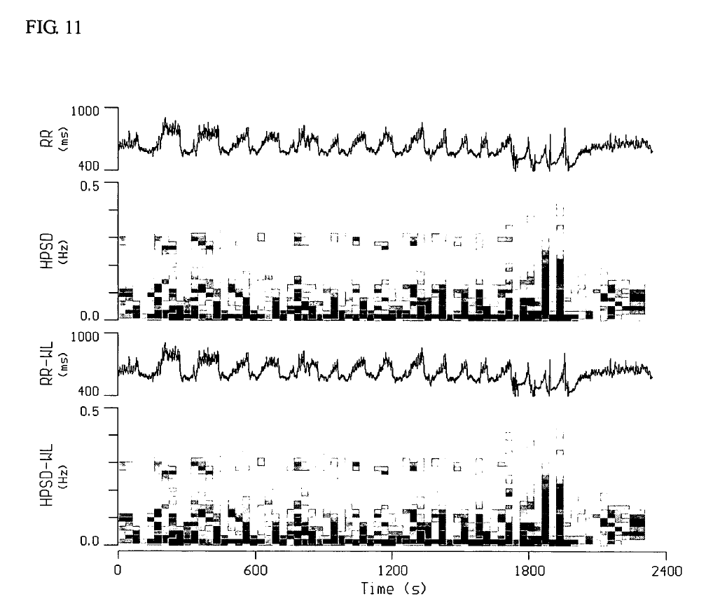

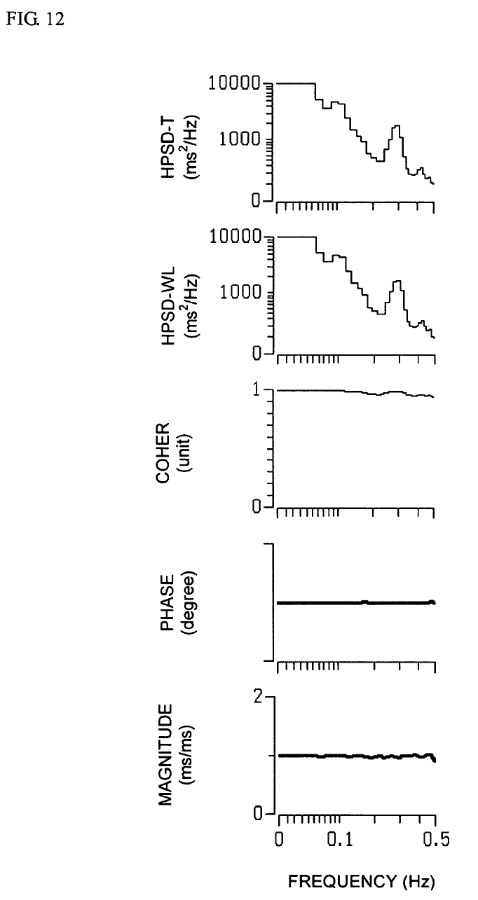

Referring to FIG. 10, the top part of FIG. 10 shows the heartbeat interval signals from a subject in the process of a 40-minute walk as detected by the physiological signal-collecting device (11) of wireless sensor (1); the bottom part shows the heartbeat interval signals emitted by the physiological signal-collecting device (11) of wireless sensor (1) as received by the wireless base station (2) in the process of the subject's 40-minute walk. Referring to FIG. 11, the top part of FIG. 11 shows heart rate variability (HRV) detected from a subject in the process of a 40-minute walk as detected by the physiological signal-collecting device (11) of wireless sensor (1); the bottom part shows the HRV signals emitted by the physiological signal-collecting device (11) of wireless sensor (1) as received by the wireless base station (2) in the process of the subject's 40-minute walk. FIG. 12 shows, from top to bottom, the frequency spectrogram of original heartbeat interval signals, the frequency spectrogram of wireless heartbeat interval signals, correlation analysis chart, phase difference diagram, and amplitude ratio diagram, in which the frequency spectrogram of the original heartbeat interval signals approximates that of the wireless heartbeat interval signals. The correlation analysis shows correlation of 1 between the original signals and wireless signals in the range of 0 to 0.5 Hz. The phase difference between the original signals and wireless signals approaches 0. The amplitude ratio of original signals and wireless signals also approaches 1. It can be observed from the experimental results that signals detected by the physiological signal-collecting device (11) match the signals received by wireless base station (2).

The experimental results as shown in FIG. 4˜FIG. 12 demonstrate the reliability of the multi-antenna wireless sensor system of the invention.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A multi-antenna wireless sensor system, comprising:
(a) a portable wireless sensor comprising:
(i) a physiological signal collecting device for outputting a physiological signal corresponding to a physiological state of a subject;
(ii) a control module for processing the physiological signal and converting it into an electrical signal;
(iii) a wireless transmission module, being a wireless data transmission interface for converting the electrical signal into a wireless signal and transmitting said wireless signal; and
(iv) a power supply unit, being a portable power source and supplying power needed by the wireless sensor;
(b) a wireless base station for transmitting the wireless signals from the wireless transmission module and communicating with the wireless transmission module, and comprising a plurality of wireless transceivers;
(c) a network device; and
(d) a data processing unit;
wherein the wireless transmission module has the same wireless transmission protocol as the wireless base station; through the arrangement of said wireless transceiver, the wireless sensor is able to remotely or movably maintain data communication with the data processing unit; the signals output by the wireless sensor being sent via the wireless base station and the network device to the data processing unit where post-processing of the feedback data is carried out.

2. The multi-antenna wireless sensor system according to claim 1, wherein the data processing unit calculates position of wireless sensor based on the transmission sequential difference between the wireless transceivers of the wireless base station and coordinate of each wireless transceiver.

3. The multi-antenna wireless sensor system according to claim 1, wherein the power supply unit includes rechargeable secondary battery.

4. The multi-antenna wireless sensor system according to claim 3, wherein the secondary battery in the power supply unit is a lithium battery, a nickel-metal-hydride battery, or a lead-acid battery.

5. The multi-antenna wireless sensor system according to claim 1, wherein the power supply unit contains a portable power generating device.

6. The multi-antenna wireless sensor system according to claim 1, wherein the portable power generating device in the power supply unit is a fuel cell or a solar cell.

7. The multi-antenna wireless sensor system according to claim 1, wherein the wireless transmission module receives data sent by the wireless base station, and simultaneously, converts the data into the electrical signal and transmits it to the wireless sensor.

8. The multi-antenna wireless sensor system according to claim 1, wherein the wireless transmission module further comprises an antenna device and a modulator-demodulator, wherein the antenna device emits signals output by the wireless sensor to the wireless base station and receives wireless signals emitted by the wireless base station; and the modulator-demodulator modulates the electrical signal output by the control module into carrier wave of specific frequency and send it to the wireless base station via the antenna device.

9. The multi-antenna wireless sensor system according to claim 8, wherein the modulator-demodulator demodulates the signals received by the antenna device into a digital signal and transmits it to the control module of wireless sensor for corresponding computing or operation.

10. The multi-antenna wireless sensor system according to claim 1, wherein the physiological signal-collecting device detects neural signals, electrocardiogram signals, electromyogram signals or vocal signals.

11. The multi-antenna wireless sensor system according to claim 10, wherein the physiological signal-collecting device is an electrocardiogram-signal-collecting device for detecting electrocardiogram signals, and the physiological signal-collecting device comprises an amplifier module, which further consists of an input filter, a differential amplifier, and an output filter.

12. The multi-antenna wireless sensor system according to claim 11, wherein the input filter removes noise to enhance the signal-to-noise ratio and the differential amplifier subjects the signal input by electrodes to common-mode noise attenuation and amplifies the electrocardiogram signal differential by a proper factor, and the output filter eliminates the Nyquist frequency of differential amplified signal.

13. The multi-antenna wireless sensor system according to claim 1, wherein the control module consists of an analog-digital converter and a microprocessor, the analog-digital converter converts the analog signal output by the amplifier module into a digital signal with proper voltage resolution and sampling frequency, the microprocessor compresses the digital signal output by the analog-digital converter to generate a digital electrocardiogram signal.

14. The multi-antenna wireless sensor system according to claim 1, wherein the network device further comprises a network server for carrying out network addressing and packet exchange with the wireless sensor through electrical connection of network device and wireless transmission of wireless base station, and further allows the data processing unit to remotely monitor or control the wireless sensor.

15. The multi-antenna wireless sensor system according to claim 1, wherein the data processing unit further comprises a monitor having display and operation functions to enable the user to monitor or control the operations of wireless sensor.

16. The multi-antenna wireless sensor system according to claim 1, wherein the wireless sensor further comprises a positioning device, which is an electric device compatible with a global positioning system and contains a positioning-satellite-signal-receiving means and a means that converts satellite signal into position signal to respectively receive the signal transmitted by a positioning satellite and convert the satellite signals received into a position signal, and then transmit the position signal to the microprocessor of control module, wherein the microprocessor controls the transmission of said position signal to wireless base station through the wireless transmission module, and finally transmits the signal to the data processing unit through the network device to make the data processing unit obtain the location of the wireless sensor.

17. The multi-antenna wireless sensor system according to claim 16, wherein the positioning-satellite-signal-receiving means is a satellite signal receiver, and the means that converts satellite signal to position signal is an electrical loop where the satellite signal received by the positioning device is converted into a position signal by the control module and sent to the data processing unit via the wireless transmission module and the network device.

18. The multi-antenna wireless sensor system according to claim 16, wherein the positioning-satellite-signal-receiving means is a satellite signal receiver, while the means that converts satellite signals into position signal is achieved by the microprocessor of control module.

19. The multi-antenna wireless sensor system according to claim 18, wherein the electrical loop configuration of the means that converts satellite signals to position signal is integrated in the control module.
